(19) United States
(12) Patent Application Publication
(10) Pub. No.: US 2014/0047662 A1
(43) Pub. Date: Feb. 20, 2014

(54) WIPER DEVICE

(71) Applicant: Helmut Depondt, Kessel-Lo (BE)

(72) Inventor: Helmut Depondt, Kessel-Lo (BE)

(73) Assignee: ROBERT BOSCH GMBH, Stuttgart (DE)

(21) Appl. No.: 13/994,101

(22) PCT Filed: Nov. 8, 2011
(86) PCT No.: PCT/EP11/69622

§ 371 Date: Nov. 11, 2013

(30) Foreign Application Priority Data
Dec. 13, 2010 (DE) 10 2010 062 925.1

(51) Int. Cl. B60S 1/40

(52) U.S. Cl. CPC B60S 1/4077; B60S 1/4074
USPC 15/250.32

(57) ABSTRACT

The invention is based on a wiper device for a motor vehicle window, with a wiper arm adapter unit (10a-10d) and a wiper blade adapter unit (12a-12d), which, in a fitted state, form a form-fitting connection, and with a fastening recess (20a-20d). It is proposed that the wiper device has a positionally fixed fastening means (18a-18d) for engaging in the fastening recess (20a-20d) in order to restrict the wiper arm adapter unit (10a-10d) in the freedom of movement thereof in the fitted state.

### BACKGROUND OF THE INVENTION

A wiper device for a motor vehicle window having a wiper arm adapter unit and a wiper blade adapter unit which form a positively locking connection in an assembled state, and having a fastening recess is already known.

### SUMMARY OF THE INVENTION

The invention proceeds from a wiper device for a motor vehicle window having a wiper arm adapter unit and a wiper blade adapter unit which form a positively locking connection in an assembled state, and having a fastening recess.

It is proposed that the wiper device has a stationary fastening means which is provided for engaging into the fastening recess, in order to limit the freedom of movement of the wiper arm adapter unit in the assembled state. As a result, particularly simple assembly of the wiper arm adapter unit with the wiper blade adapter unit can take place. In this context, a “wiper blade adapter unit” is to be understood to mean, in particular, an adapter unit which has a contact region with respect to a wiper blade component and is connected captively to the wiper blade component and is provided for producing a coupling region of the wiper blade component for coupling and/or contact with the wiper arm adapter unit. The wiper blade adapter unit preferably has a main body which provides a coupling surface for coupling and/or contact of the wiper arm adapter unit. In this context, a “wiper arm adapter unit” is to be understood to mean, in particular, an adapter unit which has a contact region with respect to a wiper arm component and is connected captively to the wiper arm component and is provided for producing a coupling region of the wiper arm component for coupling and/or contact with the wiper blade adapter unit. In this context, “provided” is to be understood to mean, in particular, specifically equipped and/or designed. In this context, a “mounted state” is to be understood to mean, in particular, a state, in which the wiper blade adapter unit and the wiper arm adapter unit are coupled to one another.

If the fastening means limits the freedom of movement of the wiper arm adapter unit in the assembled state in a longitudinal direction of the wiper blade adapter unit, assembly of the wiper device can take place in a particularly simple manner. In this context, a “longitudinal direction” is to be understood to mean, in particular, a direction which extends at least substantially parallel to a main direction of extent of the wiper blade adapter unit. In this context, “substantially” is to be understood to mean, in particular, a deviation of less than 10°.

It is proposed in a further refinement that the fastening means is arranged in a stationary manner on the wiper arm adapter unit, as a result of which the wiper device can be of particularly robust configuration. In this context, “stationary” is to be understood to mean, in particular, immovable.

Furthermore, it is proposed that the fastening means is configured as a fastening pin. As a result, the fastening means can be produced in a particularly simple manner.

If a main direction of extent of the fastening pin extends at least substantially parallel to a transverse direction of the wiper arm adapter unit, a movement of the wiper arm adapter unit relative to the wiper blade adapter unit can be avoided particularly simply in at least one operating state in the longitudinal direction. In this context, a “transverse direction” is to be understood to mean, in particular, a direction which lies perpendicularly with respect to the longitudinal direction and perpendicularly with respect to a vertical direction and runs parallel to a wiping plane. In this context, a “wiping plane” is to be understood to mean, in particular, an idealized plane which is wiped in an operating state by a wiper blade which is fastened to the wiper blade adapter unit. Here, in this context, a “vertical direction” is to be understood to mean, in particular, a direction which lies perpendicularly with respect to the wiping plane.

If the fastening recess extends in a main extent at least substantially in a vertical direction of the wiper arm adapter unit, the wiper arm adapter unit can be coupled to the wiper blade adapter unit in a particularly simple manner. In this context, a “main extent” is to be understood to mean, in particular, as great an extent as possible.

If the fastening recess extends in a main extent at least substantially in a longitudinal direction of the wiper blade adapter unit, a movement of the wiper arm adapter unit relative to the wiper blade adapter unit in a vertical direction can be avoided in a particularly simple manner.

If, furthermore, the wiper device has a locking means which is provided to avoid a movement of the fastening means relative to a main body of the wiper blade adapter unit in at least one operating state, operational security of the wiper device in an operating state can be increased in a particularly advantageous manner.

If, moreover, the wiper device has a latching means which is provided to avoid a movement of the fastening means relative to a main body of the wiper blade adapter unit in at least one operating state, coupling of the wiper arm adapter unit to the wiper blade adapter unit can take place in a particularly rapid manner.

If the latching means is configured in one piece with the main body of the wiper blade adapter unit, the wiper device can be produced in a particularly robust and inexpensive manner.

### BRIEF DESCRIPTION OF THE DRAWINGS

Further advantages result from the following description of the drawings. Exemplary embodiments of the invention are shown in the drawings. The drawings, the description and the claims contain numerous features in combination. A person skilled in the art will also expediently consider the features individually and combine them to form appropriate further combinations.

In the drawings:

FIGS. 1a to 1c show a perspective view of a wiper device in an assembly sequence,

FIGS. 2a and 2b show a perspective view of a further exemplary embodiment of a wiper device in an assembly sequence,

FIGS. 3a and 3b show a perspective view of a further exemplary embodiment of a wiper device in an assembly sequence, and

FIGS. 4a to 4c show a perspective view of a further exemplary embodiment of a wiper device in an assembly sequence.

### DETAILED DESCRIPTION

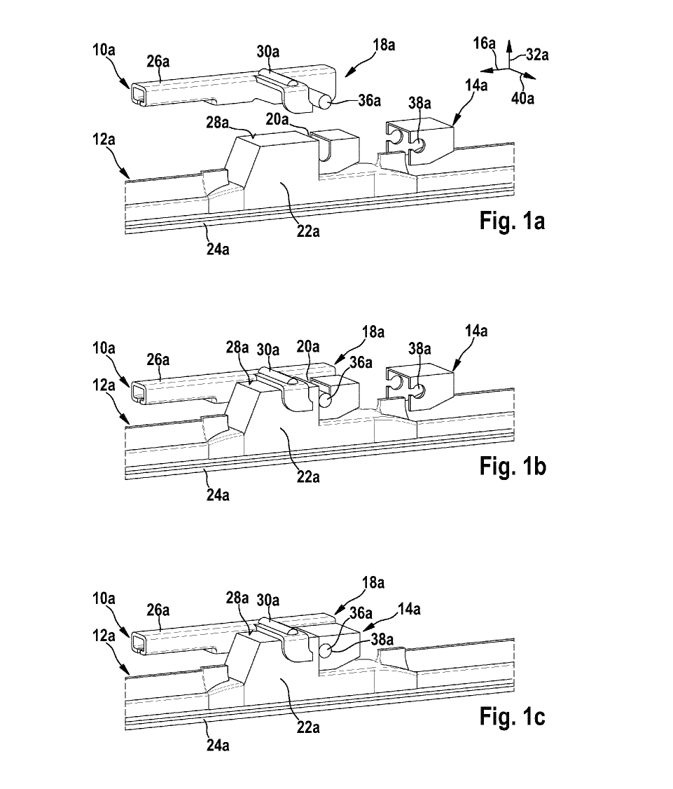

FIG. 1a shows a wiper device having a wiper arm adapter unit 10a and a wiper blade adapter unit 12a in an open state. The wiper arm adapter unit 10a has a fastening means 18a and a bearing plate 30a and is connected in one piece to a wiper arm 26a; “in one piece” is to be understood to mean, in particular, with a material-to-material connection and/or cast in one piece and/or as a result of the production using a single-component or multiple-component injection molding method. However, it is also conceivable in this context to configure the wiper arm adapter unit 10a separately from the wiper arm 26a and to connect them to one another via a suitable connecting element.

The fastening means 18a is arranged as a fastening pin 36a in a stationary manner on the wiper blade adapter unit 12a and extends cylindrically in a main direction of extent substantially parallel to a transverse direction 40a of the wiper arm adapter unit 10a. The bearing plate 30a extends first of all in the transverse direction 40a and then bends away counter to a vertical direction 32a.

The wiper blade adapter unit 12a has a freely movable locking means 14a with a substantially u-shaped profile and two substantially c-shaped latching recesses 38a.

FIG. 1b shows the wiper device in a second assembly step. The bearing plate 30a of the wiper arm adapter unit 10a lies on a bearing face 28a of a main body 22a of the wiper blade adapter unit 12a. The fastening means 18a engages into a fastening recess 20a, extending substantially in the vertical direction 32a, of the main body 22a and forms a positively locking connection with the latter. The main body 22a is configured in one piece with a wiper blade 24a. However, it is also conceivable in this context to configure the wiper blade adapter unit 12a in one piece with the wiper blade 24a.

A freedom of movement of the wiper arm adapter unit 10a is limited in a longitudinal direction 16a. In the transverse direction 40a, the freedom of movement of the wiper arm adapter unit 10a is limited by the bent-away bearing plate 30a and by the wiper arm 26a which is connected to the wiper arm adapter unit 10a.

FIG. 1 c shows the wiper device in an assembled state. The locking means 14a is pushed over the main body 22a and engages into the latter, with the result that a movement of the fastening means 18a relative to the main body 22a in the vertical direction 32a is avoided. The fastening recess 20a engages around the fastening means 18a and forms a latching connection with the latter. As a result, the locking means 14a limits the freedom of movement of the wiper arm adapter unit 10a in the vertical direction 32a.

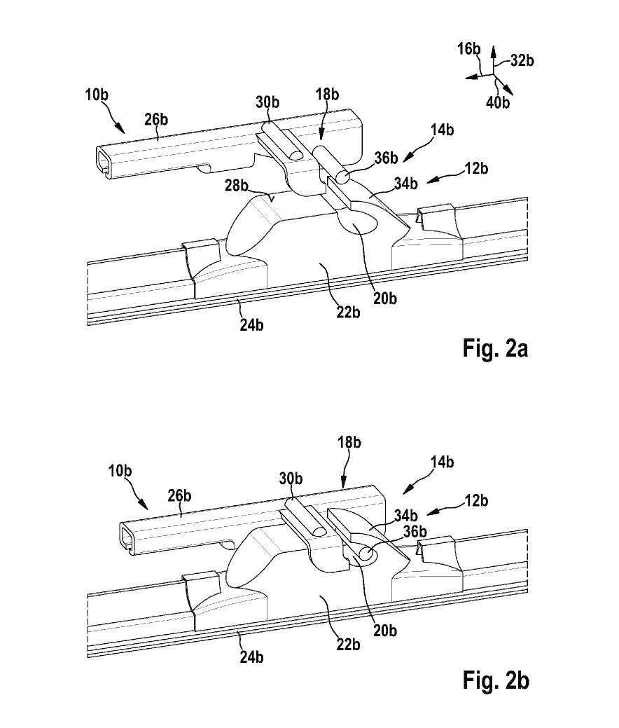

FIGS. 2 to 4 show three further exemplary embodiments of the invention. The following descriptions are restricted substantially to the differences between the exemplary embodiments, it being possible to make reference to the description of the first exemplary embodiment with regard to components, features and functions which remain the same. In order to distinguish the exemplary embodiments, the letter a in the designations of the exemplary embodiment in FIG. 1 is replaced by the letters b to d in the designations of the exemplary embodiments of FIGS. 2 to 4. Reference can in principle also be made to the drawings and/or the description of the first exemplary embodiment with regard to identically denoted components, in particular in relation to components with the same designations.

FIG. 2a shows a further exemplary embodiment of a wiper device having a wiper arm adapter unit 10b and a wiper blade adapter unit 12b in an open state. The wiper arm adapter unit 10b corresponds to the wiper arm adapter unit 10a from the first exemplary embodiment.

A main body 22b of the wiper blade adapter unit 12b is configured in one piece with a wiper blade 24b and has a locking means 14b which has a fastening recess 20b. The fastening recess 20b extends from the bearing face 28b approximately in the shape of a circular segment first of all in a vertical direction 32b and then in a longitudinal direction 16b. The fastening recess 20b has a latching means 34b which is configured in one piece with the main body 22b of the wiper blade adapter unit 12b.

FIG. 2b shows the wiper device in an assembled state. A fastening means 18b of the wiper arm adapter unit 10b is configured as a fastening pin 36b and engages into the fastening recess 20b. A movement of the fastening means 18b relative to the main body 22b of the wiper blade adapter unit 12b is avoided by way of the latching means 34b. A bearing plate 30b of the wiper arm adapter unit 10b rests on the bearing face 28b of the wiper blade adapter unit 12b.

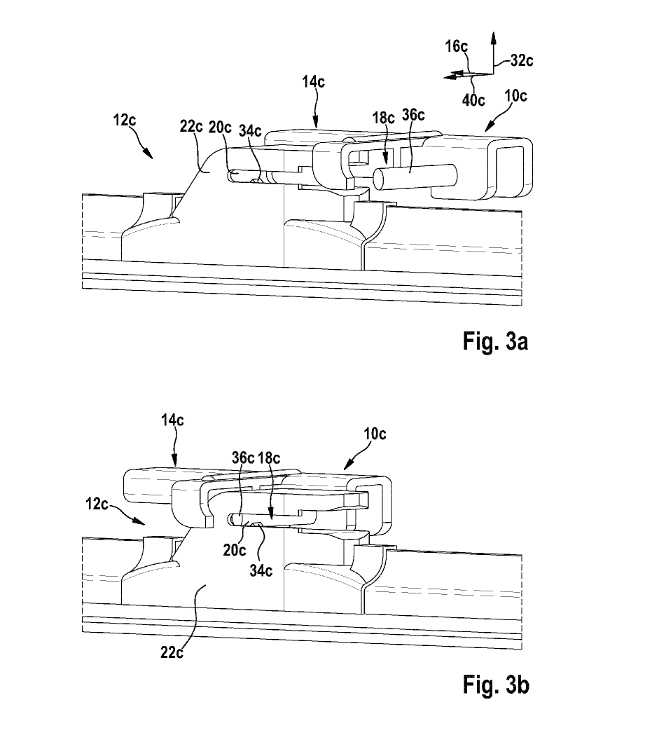

FIG. 3a shows a further exemplary embodiment of a wiper device having a wiper arm adapter unit 10c and a wiper blade adapter unit 12c in an open state. The wiper arm adapter unit 10c corresponds to the wiper arm adapter unit 10a from the first exemplary embodiment.

The wiper blade adapter unit 12c has a main body 22c with a locking means 14c. The locking means 14c has a fastening recess 20c which extends in its main direction of extent in the main body 22c substantially parallel to a longitudinal direction 16c. During assembly, the wiper arm adapter unit 10c is pushed in the longitudinal direction 16c, a fastening means 18c which is configured as a fastening pin 36c engaging into the fastening recess 20c.

FIG. 3b shows the wiper device in an assembled state. The fastening means 18c forms a positively locking connection with the main body 22c in the fastening recess 20c. A latching means 34c which is situated within the fastening recess 20c avoids the wiper arm adapter unit 10c being pushed back into the open state.

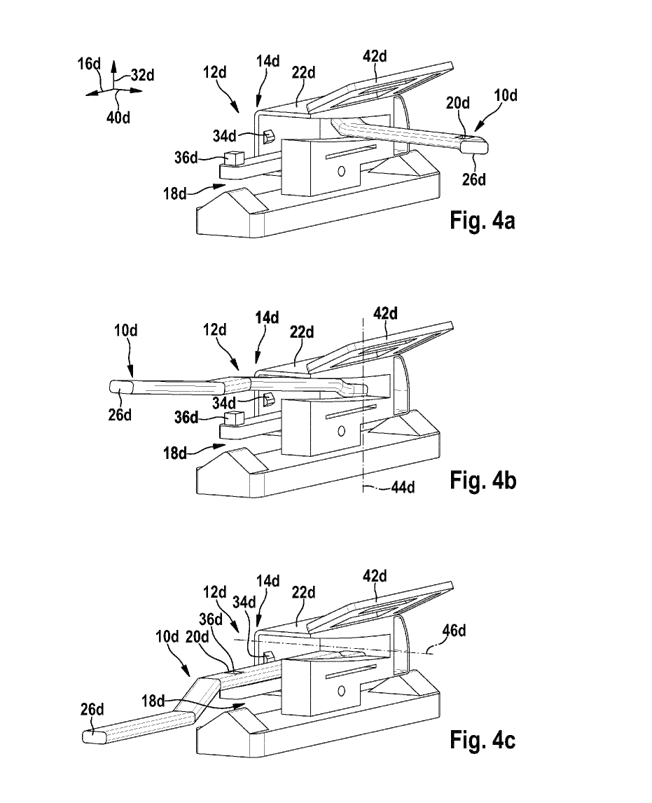

FIG. 4a shows a further exemplary embodiment of a wiper device having a wiper arm adapter unit 10d and a wiper blade adapter unit 12d in an open state. The wiper arm adapter unit 10d is connected in one piece to a wiper arm 26d and has a fastening recess 20d.

The wiper blade adapter unit 12d has a main body 22d with a locking means 14d. The locking means 14d is formed by a latching means 34d which is configured in one piece with the main body 22d. The main body 22d has, furthermore, a covering flap 42d and a fastening means 18d which is configured as a fastening pin 36d. The wiper arm adapter unit 10d bears with an outer end on an inner face of the main body 22d of the wiper blade adapter unit 12d.

FIG. 4b shows the wiper device in a second assembly step. The wiper arm adapter unit 10d is rotated about a vertical axis 44d which is arranged parallel to a vertical direction 32d. The freedom of movement of the outer end of the wiper arm adapter unit 10d is therefore limited in the vertical direction 32d and in a transverse direction 40d.

FIG. 4c shows the wiper device in a third assembly step. The wiper arm adapter unit 10d is rotated about a transverse axis 46d which runs parallel to the transverse direction 40d. The fastening recess 20d of the wiper arm 26d ends flush with the fastening pin 36d. As a result, the fastening pin 36d avoids a movement of the wiper arm adapter unit 10d in a longitudinal direction 16d.

1. A wiper device for a motor vehicle window having a wiper arm adapter unit (10a-10d) and a wiper blade adapter unit (12a-12d) which form a positively locking connection in an assembled state, and having a fastening recess (20a-20d), characterized by a stationary fastening means (18a-18d) for engaging into the fastening recess (20a-20d), in order to limit the freedom of movement of the wiper arm adapter unit (10a-10d) in the assembled state.

2. The wiper device as claimed in claim 1, characterized in that the fastening means (18a-18d) limits the freedom of movement of the wiper arm adapter unit (10a-10d) in the assembled state in a longitudinal direction (16a-16d) of the wiper blade adapter unit (12a-12d).

3. The wiper device as claimed in claim 1, characterized in that the fastening means (18a-18c) is arranged on the wiper arm adapter unit (10a-10c).

4. The wiper device as claimed in claim 1, characterized in that the fastening means (18a-18d) is configured as a fastening pin (36a-36d).

5. The wiper device as claimed in claim 1, characterized in that a main direction of extent of the fastening pin (36a-36c) extends at least substantially parallel to a transverse direction (40a-40c) of the wiper arm adapter unit (10a-10c).

6. The wiper device as claimed in claim 1, characterized in that the fastening recess (20a; 20b; 20d) extends in a main extent at least substantially in a vertical direction (32a; 32b; 32d) of the wiper arm adapter unit (10a; 10b; 10d).

7. The wiper device as claimed in claim 1, characterized in that the fastening recess (20c) extends in a main extent at least substantially in a longitudinal direction (16c) of the wiper blade adapter unit (12c).

8. The wiper device as claimed in claim 1, characterized by a locking means (14a-14d) which avoids a movement of the fastening means (18a-18d) relative to a main body (22a-22d) of the wiper blade adapter unit (12a-12d) in at least one operating state.

9. The wiper device as claimed in claim 1, characterized by a latching means (34a-34d) which avoids a movement of the fastening means (18b-18d) relative to a main body (22b-22d) of the wiper blade adapter unit (12b-12d) in at least one operating state.

10. The wiper device as claimed in claim 9, characterized in that the latching means (34b-34d) is configured in one piece with the main body (22b-22d) of the wiper blade adapter unit (12b-12d).

11. A wiper blade adapter unit of a wiper device as claimed in claim 1.

12. A wiper blade having a wiper blade adapter unit as claimed in claim 11.
